(19) United States
(12) Patent Application Publication
(10) Pub. No.: US 2018/0250577 A1
(43) Pub. Date: Sep. 6, 2018

(54) MOUTHGUARD AND FABRICATING METHOD THEREOF

(71) Applicant: Shun Hsiang Plastic Co, Ltd., Guanyin Township (TW)

(72) Inventor: Chih-Ju Lin, Guanyin Township (TW)

(21) Appl. No.: 15/971,568

(22) Filed: May 4, 2018

Related U.S. Application Data
(63) Continuation of application No. 15/047,370, filed on Feb. 18, 2016.
Application No. 15/047,370 is a continuation of application No. 13/899,008, filed on May 21, 2013, now abandoned.

(30) Foreign Application Priority Data
Feb. 22, 2013 (TW) 102106336

(51) Int. Cl. A63B 71/08

(52) U.S. Cl. CPC A63B 71/085; B29K 2623/083; A63B 2071/0694

(57) ABSTRACT

A mouthguard includes a mouthguard body and a film structure. The mouthguard body includes a front part, a rear part and a bottom part. A trench is defined by the front part, the rear part and the bottom part collaboratively. The film structure includes a first surface and a second surface. A marked pattern is printed on the second surface. The second surface of the film structure is attached on an outer surface of the front part of the mouthguard body while the mouthguard body is produced by an injection molding process, so that ink or pigment of the marked pattern is confined between the mouthguard body and the film structure without being exposed to outside.

### CROSS-REFERENCE TO RELATED APPLICATION

This application is a Continuation Application of U.S. patent application Ser. No. 15/047,370 filed on Feb. 18, 2016 and entitled “MOUTHGUARD AND FABRICATING METHOD THEREOF”, which is a Continuation Application of U.S. patent application Ser. No. 13/899,008 filed on May 21, 2013 and entitled “MOUTHGUARD AND FABRICATING METHOD THEREOF”, the entirety of which is hereby incorporated by reference.

### FIELD OF THE INVENTION

The present invention relates to a mouthguard and a fabricating method thereof, and more particularly to a mouthguard with a marked pattern and a fabricating method thereof.

### BACKGROUND OF THE INVENTION

A mouthguard is a flexible protective device for covering and wrapping teeth and gums in order to protect upper and lower teeth, cheeks and other tissues. Generally, the mouthguard has the functions of transferring forces and redistributing forces. The mouthguard is widely used to prevent injury in intense or contact sports such as boxing, taekwondo, sanda, wrestling, basketball, soccer, rugby, ice hockey or hockey. When an external force is exerted on the cheek and the lower face, the mouthguard worn within the mouth can absorb and redistribute the force. In other words, the mouthguard can effectively protect the hard tissues (e.g. the teeth or the mandible) and the peripheral soft tissues from injuries (e.g. the occurrence of the sports injuries of breaking off, dropping down or shifting the teeth) or even prevent and reduce sports concussion. Consequently, the use of the mouthguard can enhance the athletic performance.

Generally, a mark is formed on the mouthguard to indicate the manufacturer, the race team name or the representative picture or increase the aesthetic style or color. In a conventional method for forming the mark on the mouthguard, a recessed portion is firstly formed in the mouthguard and then a colored material is filled into the recessed portion. Alternatively, a hole is firstly formed in the mouthguard and then a colored sheet is placed in a storing portion, so that the pattern of the hole is shown through the opening and the colored sheet. Alternatively, the mark is included in the mold of forming the mouthguard. Alternatively, a two-color or multi-color mouthguard is produced. However, the fabricating cost of the conventional method is very high, and the diversity of the pattern and color is usually unsatisfied.

For increasing the diversity of the pattern and color, a simple method is to directly print the desired pattern on an outer surface of the mouthguard or attach a label sticker on the outer surface of the mouthguard. However, since the mouthguard should be heated and softened to allow the mouthguard to properly fit the shape of the teeth before use, some drawbacks may occur. For example, during the mouthguard is heated, the pigment printed on the mouthguard or the ink on the label sticker is readily peeled off. Under this circumstance, the marked pattern becomes blurred, and even the peeled pigment or ink is usually harmful to the user's health.

Therefore, there is a need of providing an improved mouthguard in order to eliminate the above drawbacks.

### SUMMARY OF THE INVENTION

The present invention provides a mouthguard with a marked pattern. According to the present invention, the possibility of peeling off the pigment or ink from the marked pattern will be minimized, and thus the use of the mouthguard is not harmful to human health.

The present invention also provides a method of fabricating a mouthguard in a simplified and cost-effective manner.

In accordance with an aspect of the present invention, there is provided a mouthguard. The mouthguard includes a mouthguard body and a film structure. The mouthguard body includes a front part, a rear part and a bottom part. A trench is defined by the front part, the rear part and the bottom part collaboratively. The film structure includes a first surface and a second surface. A marked pattern is printed on the second surface. The second surface of the film structure is attached on an outer surface of the front part of the mouthguard body while the mouthguard body is produced by an injection molding process, so that ink or pigment of the marked pattern is confined between the mouthguard body and the film structure without being exposed to outside.

In accordance with another aspect of the present invention, there is provided a method of fabricating a mouthguard. The method includes the following steps. Firstly, a film structure including a first surface and a second surface is provided, wherein a marked pattern is previously printed on the second surface. Then, the film structure is placed within a mold cavity, wherein the first surface of the film structure is in contact with an inner surface of the mold cavity. Then, an injection molding process is performed to produce a mouthguard body including a front part, a rear part and a bottom part, wherein a trench is defined by the front part, the rear part and the bottom part collaboratively. Moreover, the second surface of the film structure is attached on an outer surface of the front part of the mouthguard body while the mouthguard body is produced by the injection molding process, so that ink or pigment of the marked pattern is confined between the mouthguard body and the film structure without being exposed to outside.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a mouthguard according to a first embodiment of the present invention;

FIG. 1B is a schematic exploded view illustrating the mouthguard of FIG. 1A;

FIG. 2 is a flowchart illustrating a method of fabricating a mouthguard according to an embodiment of the present invention;

FIG. 3A is a schematic perspective view illustrating a mouthguard according to a second embodiment of the present invention;

FIG. 3B is a schematic exploded view illustrating the mouthguard of FIG. 3A; and

FIG. 3C is a schematic exploded view illustrating a mouthguard according to a third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

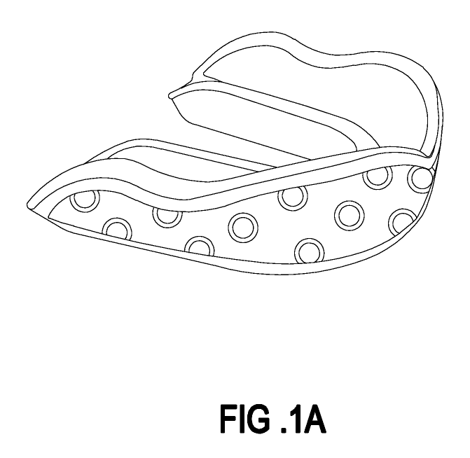

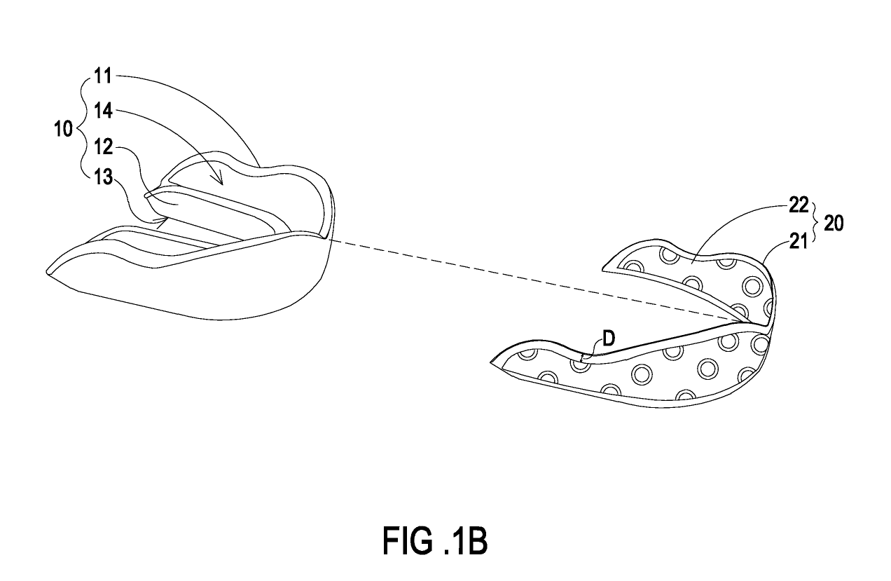

FIG. 1A is a schematic perspective view illustrating a mouthguard according to a first embodiment of the present invention. FIG. 1B is a schematic exploded view illustrating the mouthguard of FIG. 1A. As shown in FIGS. 1A and 1B, the mouthguard comprises a mouthguard body 10 and a film structure 20 with a marked pattern. The mouthguard body 10 is substantially a U-shaped base having a shape matching the teeth. In this embodiment, the mouthguard body 10 comprises a front part 11, a rear part 12 and a bottom part 13. Moreover, a trench 14 is defined by the front part 11, the rear part 12 and the bottom part 13 collaboratively. The trench 14 is used for accommodating the teeth. The film structure 20 has a first surface 21 and a second surface 22. A marked pattern is printed on the second surface 22. More especially, the second surface 22 of the film structure 20 is attached on an outer surface of the front part 11 of the mouthguard body 10 while the mouthguard body 10 is produced by an injection molding process. As a consequence, the ink or pigment of the marked pattern is confined between the mouthguard body 10 and the film structure 20 without being exposed to outside.

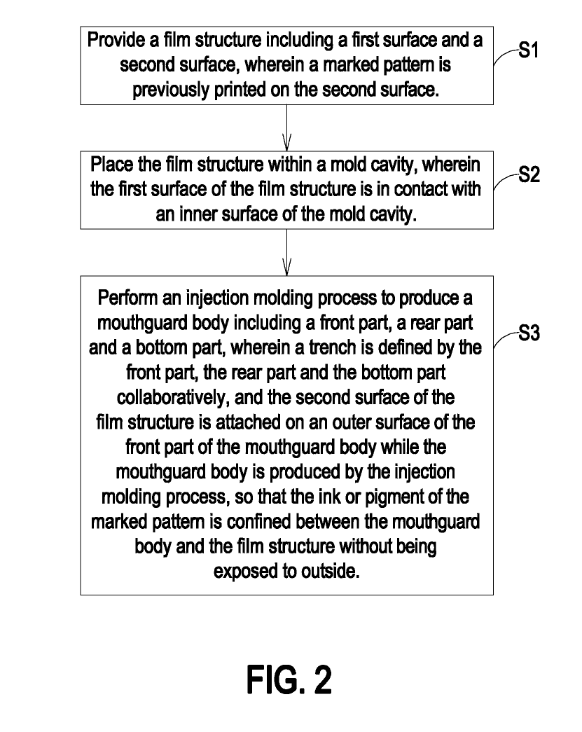

Hereinafter, a method of fabricating the mouthguard will be illustrated with reference to the exploded view of FIG. 1B and the flowchart of FIG. 2. Firstly, in the step S1, a film structure 20 is provided. The film structure 20 has a first surface 21 and a second surface 22, which are opposed to each other. A marked pattern is previously printed on the second surface 22 of the film structure 20. In an embodiment, the film structure 20 is a transparent film with a thickness of 0.1˜1.0 mm, and preferably 0.2˜0.5 mm. The film structure 20 is made of a FDA-approved thermoplastic plastic material. An example of the thermoplastic plastic material includes but is not limited to ethylene vinyl acetate (EVA) or thermal plastic elastomer (TPE).

The film structure 20 is not limited to the transparent film structure. Alternatively, in some other embodiments, the film structure 20 may be a translucent film structure or a colored film structure. Moreover, the film structure 20 may be further processed by sandblasting or embossing.

In an embodiment, a large number of marked patterns may be previously printed on a large-area film structure, and then the large-area film structure may be cut into plural film structures 20 as shown in FIG. 1B. Moreover, the size and shape of the film structure 20 substantially match the size and shape of the front part 11 of the mouthguard body 10. Preferably, the marked pattern is not completely distributed over the second surface 22 of the film structure 20. For example, there is a distance D (e.g. 1˜2 mm) between the margin of the marked pattern and the edge of the film structure 20. The region of the second surface 22 of the film structure 20 without the marked pattern can be used as a bonding area between the film structure 20 and the mouthguard body 10. Moreover, the region of the second surface 22 of the film structure 20 without the marked pattern can be used to prevent leakage of the ink or pigment, so that the adverse influence of the ink or pigment on the human health can be minimized. Moreover, since the marked pattern is created by printing, the diversity of the marked pattern will be enhanced. For example, the marked pattern may be very complex, or the marked pattern may contain multiple colors. Consequently, the marked pattern becomes more diverse and more aesthetically-pleasing.

In some other embodiments, the marked pattern on the film structure 20 may be created by a full printing process. That is, the marked pattern is completely distributed over the second surface 22 of the film structure 20, and there is no distance between the margin of the marked pattern and the edge of the film structure 20. Under this circumstance, the marked pattern may be printed on the film structure 20 with a reactive ink. Consequently, while the mouthguard body 10 is produced by an injection molding process, the film structure 20 can still be attached on the mouthguard body 10 through the reactive ink.

Then, in the step S2, the film structure 20 is placed within a mold cavity, wherein the first surface 21 (i.e. the surface without the marked pattern) is in contact with an inner surface of the mold cavity. Then, in the step S3, an injection molding process is performed to produce a mouthguard body 10. The mouthguard body 10 comprises a front part 11, a rear part 12 and a bottom part 13. Moreover, a trench 14 is defined by the front part 11, the rear part 12 and the bottom part 13 collaboratively. Especially, the second surface 22 of the film structure 20 is attached on an outer surface of the front part 11 of the mouthguard body 10 while the mouthguard body 10 is produced by the injection molding process. As a consequence, the ink or pigment of the marked pattern is confined between the mouthguard body 10 and the film structure 20 without being exposed to outside.

During the injection molding process is performed, the high pressure and high temperature can facilitate adhesion between the film structure 20 and the mouthguard body 10. When the mold is opened and the plastic article is ejected from the mold, the molding function and the pattern-transferring function are simultaneously achieved. Moreover, since the film structure 20 is placed within the mold cavity, the film structure 20 will not be protruded from the surface of the mouthguard body 10. In other words, the film structure 20 may lie flat on the surface of the mouthguard body 10. Under this circumstance, even if an external force is exerted on the film structure 20, it is difficult to peel off the film structure 20 from the mouthguard body 10.

From the above discussions, the marked pattern is printed on the second surface 22 of the film structure 20. In addition, and the second surface 22 of the film structure 20 is attached on the mouthguard body 10 while the mouthguard body 10 is produced by the injection molding process. As a consequence, the ink or pigment of the marked pattern is confined between the mouthguard body 10 and the film structure 20 without being exposed to outside. Under this circumstance, the adverse influence of the ink or pigment on the human health can be minimized, and the vivid color of the marked pattern can be maintained for a long time without being faded.

On the other hand, if a large number of marked patterns are previously printed on a large-area film structure and then the large-area film structure is cut into plural film structures 20 as shown in FIG. 1B, the cost can be largely reduced. Moreover, the marked pattern to be printed is not restricted. For example, texts, trademarks, graphics, simple or complex pattern or multi-color pattern can be easily printed as the marked pattern. Consequently, the marked pattern becomes more diverse and more aesthetically-pleasing.

In the above embodiment, the marked pattern is formed on the front part 11 of the mouthguard body 10 only. In other words, the marked pattern is a two-dimensional marked pattern. Moreover, the concepts of the present invention can be applied to form a three-dimensional marked pattern on the mouthguard.

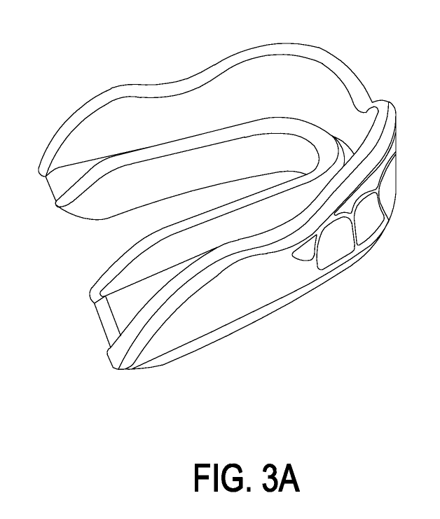

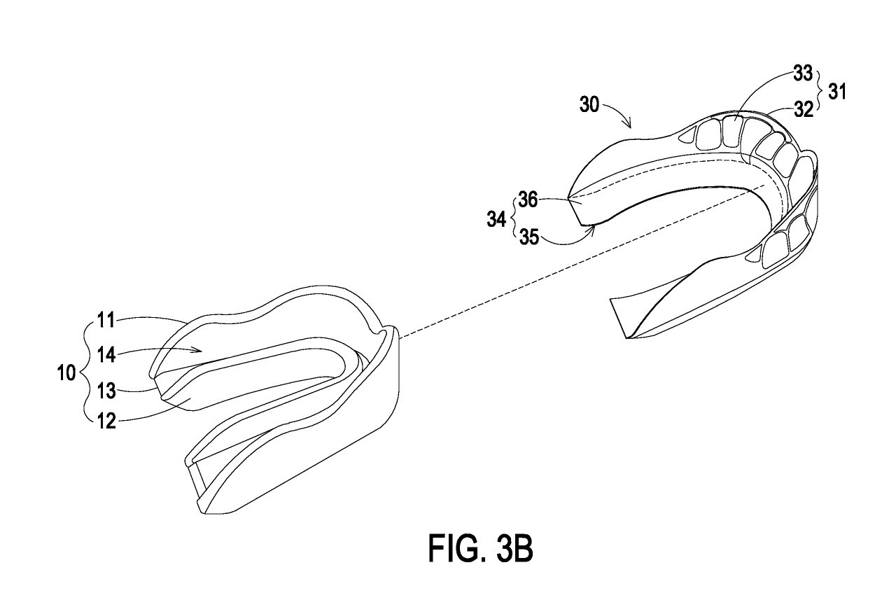

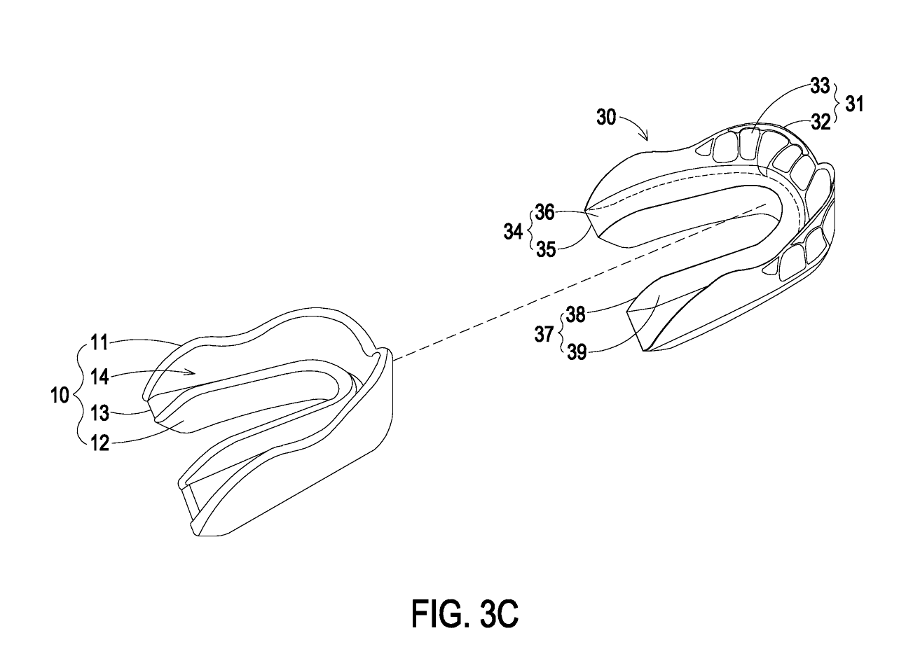

FIG. 3A is a schematic perspective view illustrating a mouthguard according to a second embodiment of the present invention. FIG. 3B is a schematic exploded view illustrating the mouthguard of FIG. 3A. As shown in FIGS. 3A and 3B, the mouthguard comprises a mouthguard body 10 and a three-dimensional film structure 30 with a marked pattern. In comparison with the mouthguard of FIG. 1B, the three-dimensional film structure 30 of this embodiment is distinguished. The three-dimensional film structure 30 comprises a first film 31 and a second film 34. The second film 34 is extended inwardly from a bottom periphery of the first film 31. Moreover, the size and shape of the first film 31 substantially match the size and shape of the front part 11 of the mouthguard body 10, and the size and shape of the second film 34 substantially match the size and shape of the bottom part 13 of the mouthguard body 10. The first film 31 comprises a first surface 32 and a second surface 33. The second film 34 comprises a third surface 35 and a fourth surface 36. The marked pattern is printed on the second surface 33 and the fourth surface 36. Moreover, the marked pattern can be extended from the second surface 33 to the fourth surface 36.

For fabricating the mouthguard of this embodiment, the three-dimensional film structure 30 is placed within a mold cavity, wherein the first surface 33 and the third surface 35 are in contact with an inner surface of the mold cavity. Then, an injection molding process is performed to produce a mouthguard body 10. While the mouthguard body 10 is produced by the injection molding process, the second surface 33 and the fourth surface 36 of the three-dimensional film structure 30 are respectively attached on the outer surfaces of the front part 11 and the bottom part 13 of the mouthguard body 10. As a consequence, the ink or pigment of the marked pattern is confined between the mouthguard body 10 and the three-dimensional film structure 30 without being exposed to outside. Moreover, since the marked pattern is shown on the front part 11 and the bottom part 13 of the mouthguard body 10, the 3D vision efficacy of the marked pattern can be exhibited.

FIG. 3C is a schematic exploded view illustrating a mouthguard according to a third embodiment of the present invention. In this embodiment, the three-dimensional film structure 30 further comprises a third film 37 corresponding to the rear part 12 of the mouthguard body 10. The third film 37 is extended upwardly from an inner periphery of the second film 34. The size and shape of the third film 37 substantially match the size and shape of the rear part 12 of the mouthguard body 10. The third film 37 comprises a fifth surface 38 and a sixth surface 39. The marked pattern is printed on the sixth surface 39 of the third film 37. Similarly, while the mouthguard body 10 is produced by the injection molding process, the second surface 33, the fourth surface 36 and the sixth surface 39 of the three-dimensional film structure 30 are respectively attached on the outer surfaces of the front part 11, the bottom part 13 and the rear part 12 of the mouthguard body 10. As a consequence, the ink or pigment of the marked pattern is confined between the mouthguard body 10 and the three-dimensional film structure 30 without being exposed to outside. Moreover, since the marked pattern is shown on the front part 11, the bottom part 13 and the rear part 12 of the mouthguard body 10, the 3D vision efficacy of the marked pattern can be exhibited.

In a preferred embodiment, the first film 31, the second film 34 and the third film 37 are integrally formed with each other. Moreover, before the marked pattern is printed, the factors influencing the three-dimensional deformation should be taken into consideration. After the marked pattern is printed on a planar film structure, the planar film structure is processed into the three-dimensional film structure 30 by a hot pressing process or a vacuum forming process. Alternatively, in some other embodiments, the first film 31, the second film 34 and the third film 37 are separate films. The first film 31, the second film 34 and the third film 37 are placed within the mold cavity, respectively. While the mouthguard body 10 is produced by the injection molding process, the second surface 33, the fourth surface 36 and the sixth surface 39 of the three-dimensional film structure 30 are respectively attached on the outer surfaces of the front part 11, the bottom part 13 and the rear part 12 of the mouthguard body 10.

From the above descriptions, the present invention provides a mouthguard and a fabricating method thereof. Firstly, a marked pattern is printed on a surface of a film structure. Then, the film structure is placed within a mold cavity. While the mouthguard body is produced by the injection molding process, the surface of the film structure with the marked pattern is attached on the mouthguard body. Consequently, the ink or pigment of the marked pattern is confined between the mouthguard body and the film structure without being exposed to outside. Since the ink or pigment of the marked pattern is not exposed to outside, the adverse influence of the ink or pigment on the human health will be minimized. Moreover, since the marked pattern is formed on the film structure by printing, the cost will be largely reduced, and the marked pattern becomes more diverse and more aesthetically-pleasing. The marked pattern used in the mouthguard of the present invention is not limited to the two-dimensional marked pattern. Moreover, the concepts of the present invention can be applied to form a three-dimensional marked pattern on the mouthguard. From the above discussions, the mouthguard and the fabricating method of mouthguard according to the present invention have industrial applicability

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of fabricating a mouthguard, said method comprising steps of:
providing a film structure having a thickness of 0.2˜0.5 mm and including a first surface and a second surface, wherein a marked pattern is previously printed on said second surface, wherein said film structure is made of ethylene vinyl acetate (EVA) or thermal plastic elastomer (TPE) to enable said film structure to be stretched or deformed while being heated, and a margin of said marked pattern and an edge of said film structure are separated from each other by a specified distance to provide a bonding area and prevent leakage of ink or pigment of said marked pattern;
placing said film structure within a mold cavity, wherein said first surface of said film structure is in contact with an inner surface of said mold cavity; and
performing an injection molding process to produce a mouthguard body including a front part, a rear part and a bottom part, wherein a trench is defined by said front part, said rear part and said bottom part collaboratively, wherein said second surface of said film structure is attached on an outer surface of said front part of said mouthguard body while said mouthguard body is produced by said injection molding process, so that the ink or pigment of said marked pattern is confined between said mouthguard body and said film structure without being exposed to outside.

2. The method according to claim 1, wherein said first surface and said second surface of said film structure are opposed to each other.

3. The method according to claim 1, wherein said film structure is a transparent film structure, a translucent film structure or a colored film structure.

4. The method according to claim 1, wherein the size and shape of said film structure substantially match the size and shape of said front part of said mouthguard body.

5. The method according to claim 1, wherein said film structure comprises a first film and a second film, wherein said first film has said first surface and said second surface, and said second film has a third surface and a fourth surface.

6. The method according to claim 5, wherein said marked pattern is previously printed on said second surface and said fourth surface, wherein said fourth surface of said film structure is attached on an outer surface of said bottom part of said mouthguard body while said mouthguard body is produced by said injection molding process.

7. The method according to claim 6, wherein said film structure comprises a third film including a fifth surface and a sixth surface, wherein said marked pattern is previously printed on said second surface, said fourth surface and said sixth surface, wherein said sixth surface of said film structure is attached on an outer surface of said rear part of said mouthguard body while said mouthguard body is produced by said injection molding process.

8. The method according to claim 1, wherein said specified distance is 1˜2 mm.
